(19) United States
(12) Patent Application Publication
(10) Pub. No.: US 2014/0192200 A1
(43) Pub. Date: Jul. 10, 2014

(54) MEDIA STREAMS SYNCHRONIZATION

(71) Applicant: HII MEDIA LLC, Paramus, NJ (US)

(72) Inventor: Guy ZAGRON, Lapid (IL)

(73) Assignee: HII MEDIA LLC, Paramus, NJ (US)

(21) Appl. No.: 13/736,208

(22) Filed: Jan. 8, 2013

(51) Int. Cl. G06F 3/00

(52) U.S. Cl. CPC G06F 3/005
USPC 348/159; 348/207.1

(57) ABSTRACT

A method and system for media streams synchronization. The system comprising a mobile device comprising a video camera configured to capture a video stream; and an audio-video binding module, implemented using at least a processor, wherein said synchronization module is configured to generate a multimedia stream comprising the video stream and an audio stream, wherein the audio stream is generated by an external device to the mobile device and wherein said audio-video binding module is configured to synchronize between the audio and video streams based on correlating timing indications in both the audio and video streams.

### TECHNICAL FIELD

The present disclosure relates to multimedia files in general, and to synchronization of media streams, in particular.

### BACKGROUND

Multimedia is media and content that uses a combination of different content forms. Multimedia includes a combination of text, audio, still images, animation, video, or interactivity content forms. Multimedia is usually recorded and played, displayed, or accessed by information content processing devices, such as computerized and electronic devices, but can also be part of a live performance. Multimedia devices are electronic media devices used to store and experience multimedia content.

State of the art mobile devices, such as but not limited to smart phones, Personal Digital Assistants (PDAs), tablet computers, or the like, are equipped with recording devices enabling capturing of multiple content forms. In particular, a microphone of a mobile device may be used to capture an audio stream, preferably in a digital format, while a camera may be used to capture a video stream, preferably in digital format. In some cases, both streams may be captured simultaneously to provide for a multimedia stream comprising of both sequence of images (i.e., video stream) and corresponding sound (i.e., audio stream).

Recordation equipment of the mobile device may record distorted audio waves. Distortions may be caused due to background noise by a secondary source, such as the case when capturing an audio stream of a live concert or show while near the crowd, which may introduce background noise that is not part of the original audio stream. Furthermore, the recordation equipment of the mobile device may have limitations, such as a limitation on the ability of the microphone to capture audio that is not directly aimed at it.

the microphone may be limited in bit-rate capturing capabilities, in its ability to capture sound bits of different wave lengths, or the like. The captured audio stream may therefore be distorted due to any kind of deformation of an output waveform compared to its input, such as but not limited to clipping, harmonic distortion, or intermodulation distortion (mixingphenomena) caused by non-linear behavior of electronic components and power supply limitations. Additionally or alternatively, distortions may be caused due to background noise by a secondary source, such as the case when capturing an audio stream of a live concert or show while near the crowd, which may introduce background noise that is not provided by the original audio stream.

### BRIEF SUMMARY

One exemplary embodiment of the disclosed subject matter is a computerized system comprising: a mobile device comprising a video camera configured to capture a video stream; and an audio-video binding module, implemented using at least a processor, wherein said synchronization module is configured to generate a multimedia stream comprising the video stream and an audio stream, wherein the audio stream is generated by an external device to the mobile device and wherein said audio-video binding module is configured to synchronize between the audio and video streams based on correlating timing indications in both the audio and video streams.

In some exemplary embodiments, the mobile device comprising the audio-video binding module.

In some exemplary embodiments, the mobile device comprising a receiver configured to receive from an external source the timing indications during capturing of the video stream, and wherein correlating timing indications are comprised in the audio stream.

In some exemplary embodiments, the audio-video binding module is comprised by a server, wherein the server is configured to obtain a plurality of video streams from a plurality of mobile devices and generate the multimedia stream based on the plurality of video streams and the audio stream.

In some exemplary embodiments, the server is configured to provide for a crowd-sourced music clip of a live show performed in a location, and wherein the plurality of mobile devices were located at the location and were used to record the live show at least using their respective video cameras.

In some exemplary embodiments, the server is configured to select portions of the plurality of video streams based on user input.

In some exemplary embodiments, the system further comprising a video-audio matcher, wherein said video-audio matcher is configured to obtain the audio stream that correlates to the video stream based on meta-data of the video stream.

In some exemplary embodiments, the meta-data comprises: geo-location in which the video stream was recorded and time of recording.

In some exemplary embodiments, the meta-data comprises a unique identifier of a show, wherein the meta-data was obtained by a receiver of the mobile device substantially during a time in which the mobile device recorded the video stream.

In some exemplary embodiments, said audio-video binding module is operatively coupled to a rights management module, wherein the rights management module is configured to provide access to copyrighted audio streams in response to payment.

In some exemplary embodiments, the audio stream is generated by a sound reinforcement system, wherein the mobile device captured the video stream while located at a location in which audio emitted by the sound reinforcement system is audible.

In some exemplary embodiments, the mobile device is capable of capturing a distorted version of the audio stream.

In some exemplary embodiments, the distorted version of the audio stream is distorted due to at least one of the following: a limitation of a microphone of the mobile device; and background noise by a crowd.

Another exemplary embodiment of the disclosed subject matter is a computer-implemented method performed by a processor, the method comprising: obtaining an audio stream and a video stream, wherein the video stream was captured by a mobile device having a camera, and wherein the audio stream was captured by an external device that is external to the mobile device; and binding, by the processor, the audio stream and the video stream to generate a multimedia stream comprising the audio stream and video stream, wherein said binding comprising synchronizing between the audio stream and the video stream based on correlating timing indications in both the audio and video streams.

In some exemplary embodiments, the mobile device comprising the processor, and said binding is performed by the mobile device.

In some exemplary embodiments, the audio and video streams each comprising timing indications, wherein the timing indications are generated by an external source to the mobile device and transmitted to both the mobile device and the external device simultaneously.

In some exemplary embodiments, the mobile device receiving the audio stream while capturing the video stream, and wherein said binding is performed in real-time.

In some exemplary embodiments, said binding is performed in response to authorizing access to the audio stream.

In some exemplary embodiments, said authorizing is based on a payment of a licensing fee.

In some exemplary embodiments, said authorizing comprises determining whether the video stream was captured at a same location in which a distorted version of the audio stream was recordable by the mobile device, whereby enabling a user of the mobile device to capture the video stream and an undistorted version of the audio stream.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a schematic illustration of a computerized environment, in accordance with some embodiments of the disclosed subject matter;

FIGS. 1B-1C show exemplary alternative video streams captured in the computerized environment of 1A, in accordance with some embodiments of the disclosed subject matter;

FIGS. 2A-2C show flowchart diagrams of steps in methods, in accordance with some exemplary embodiments of the disclosed subject matter; and

FIG. 3 shows a block diagram of components of a system, in accordance with some embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to allow to members of the audience to capture a multimedia stream of an event, such as a live concert, a show, or any similar event in which audio and visual stimuli are provided. In some exemplary embodiments, a user may like to capture a personalized multimedia stream from her perspective of the show.

Another problem is to allow for the audio stream to be of relatively high quality, such as 128 kb per second and be undistorted. In some exemplary embodiments, the audio capturing capabilities of a mobile device of the user may only allow for a distorted version of the original audio stream. Additionally or alternatively, background noise, such as by the crowd, may not allow for capturing of an undistorted version of the audio stream even in the absence of limitations of the audio capturing means, such a microphone.

Yet another technical problem is to regulate access to media streams of high quality, such as original audio stream that was played during the event. The audio stream may comprise of live music by a band, live singing by a vocal performer, pre-recorded version of any of the above, or the like. It may be desirable to provide the audience that was exposed to the audio stream during the event with different access permissions than other users, such as different pricing, access to version of higher quality, or the like.

Yet another technical problem is to allow for editing of a multimedia stream, which is composed of streams of different sources.

One technical solution is to bind audio and video streams of different sources to provide for a multimedia stream. In some exemplary embodiments, the audio stream may be obtained from an audio console or sound reinforcement system, or the like. The audio stream may be of a relatively high quality, such as uncompressed analog audio stream, digital audio stream sampled at a sampling rate of about 44,100 Hz or higher, compressed audio stream such as using a lossy compression algorithm (e.g., MP3 having a bit rate of about 128 kbits/s or higher), or otherwise of a quality suitable for being played in an event, such as a concert or a show, or the like. The video streams may be obtained by members of the audience using a mobile device.

Another technical solution is to synchronize the audio and video streams based on timing indications. In some exemplary embodiments, the timing indications may be generated at the location in which the video is recorded and transmitted to the mobile device to be embedded in the video stream. In some exemplary embodiments, the timing indications may include a pulse beat. Additionally or alternatively. the timing indications may be a timestamp of the stream. In some exemplary embodiments, the clock of the mobile device may be synchronized to that of the external device recording the audio stream to ensure that this information can be used to synchronize the streams.

In some exemplary embodiments, binding of the streams may be performed on the fly while the video stream is captured by streaming the audio stream to the mobile device and binding the streams substantially when the video stream is being captured. Additionally or alternatively, the binding may be performed in a later time, such as by downloading or streaming the matching audio stream at a different time to be binded to the video stream. Additionally or alternatively, the video stream may be uploaded to a server which may be configured to obtain a matching audio stream and bind it with the video stream.

In some exemplary embodiments, the audio stream may be obtained from a database of audio streams and matched to the video streams based on meta data information associated with both streams. The meta data may include administrative information obtainable at the event thereby ensuring streams were captured at the same event.

Yet another technical solution provides for crowdsourcing an audience to obtain a plurality of video streams that document the same event and combine portions thereof with an audio stream of the event. In one scenario, a music video clip of a live show can be generated based on video clips captured by the audience at the show. In some exemplary embodiments, different video streams may be used for providing a video clip having a plurality of alternative angels.

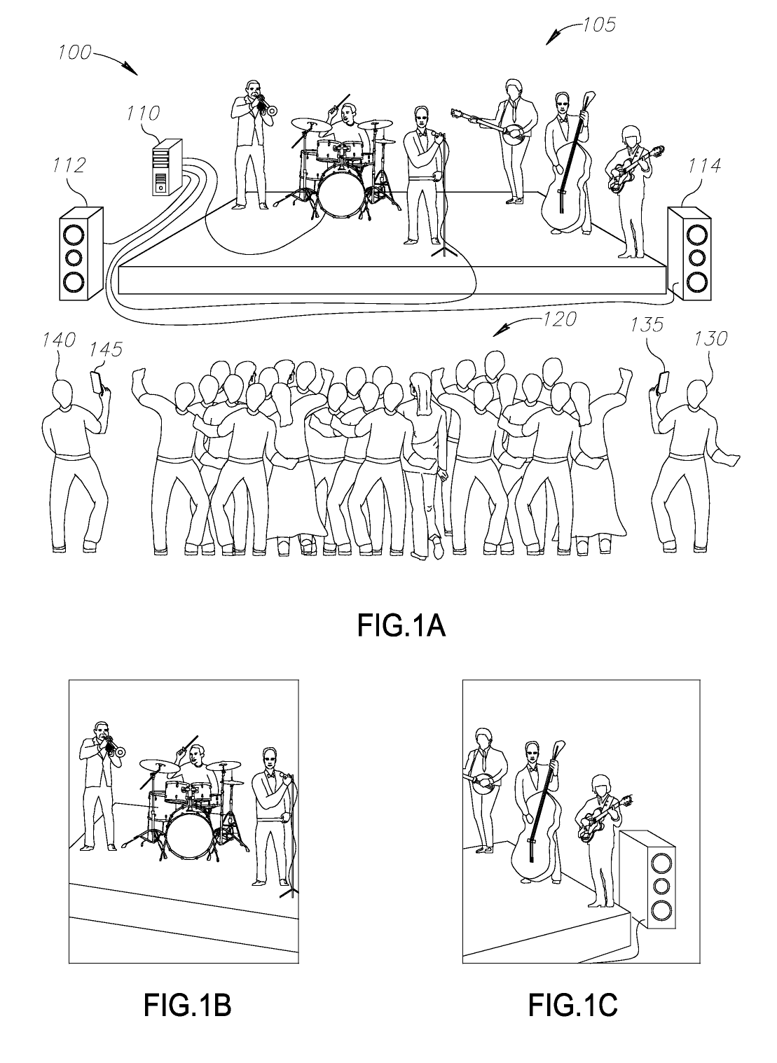

Referring FIG. 1A shows a schematic illustration of a computerized environment, in accordance with some embodiments of the disclosed subject matter. Computerized environment 100 exemplifies a live concert involving a Band 105 musicians and a singer. Audio generated by Band 105 are transmitted, wirelessly or via a wire, to a Sound Generator 110. Sound Generator 110 may be, for example, an audio console, a sound reinforcement system, or the like. In some exemplary embodiments, Sound Generator 110 may be configured to receive one or more audio inputs, mix between them, reinforce them, or perform other manipulations thereon, to generate an audio stream to be emitted by a sound system including Speakers 112, 114. In some exemplary embodiments, Sound Generator 110 may utilize pre-recorded audio inputs in addition to or instead of live audio input.

Audience 120 attends the event and hears the music emitted by Speakers 112 114. Audience 120 is located in a physical proximity of the Speakers 112, 114 so that sound emitted by Speakers 112, 114 is audible to Audience 120. However, Audience 120 may also experience background noise, such as speaking, laughing and singing by members of Audience 120.

A Person 130 may desire to capture the event using a Mobile Device 135, such as a smart phone, a PDA, a tablet, a mini-tablet, or the like. Using a camera of Mobile Device 135 a video stream of the event may be captured, such as exemplified by the image depicted in FIG. 1B. A Person 140 may likewise desire to capture the event using a Mobile Device 145 and may capture a different video stream, such as exemplified by the image depicted in FIG. 1C. As can be appreciated, each member of the audience may end up with a different video stream documenting the event.

Though Mobile Device 135 may capture an audio stream, capturing the audio stream using a microphone of the mobile devices may capture a distorted version of the audio stream generated by Sound Generator 110. The audio stream may be distorted in view of background noise, in view of limitations in the capability of the microphone (e.g., limitation in capturing non-direct waves of sound, capturing monophonic sound), in view of a distortion caused to the audio waves that were emitted by Speakers 112, 114 and until reaching Mobile Device 135, and/or in view of other reasons.

In some exemplary embodiments, Mobile Device 135 may capture a video stream and have an audio stream generated by Sound Generator 110 be binded to it to provide for a multimedia stream. In some exemplary embodiments, the streams may be provided in digital form.

In some exemplary embodiments, binding the streams may be performed by synchronizing between the streams. The synchronization may be based on timing indications which may embedded in the streams. In some exemplary embodiments, in order to ensure synchronization, a clock of Mobile Device 135 may be synchronized with clock of Sound Generator 110. In some exemplary embodiments, Sound Generator 110 may periodically emit signals, also referred to as pulses, which may be used to synchronize the clocks. In some exemplary embodiments, Mobile Device 135 may embed in the video stream the information received in the pulse in a time corresponding to the time of receipt of the pulse by Mobile Device 135.

In some exemplary embodiments, administrative information, such as event information, licensing information, or the like, may be sent by Sound Generator 110 and received by Mobile Device 135.

In some exemplary embodiments, Mobile Device 135 may embed in the video stream meta-data such as but not limited to geo-location of the device while capturing the video stream, administrative information of the event, timing information, or the like. Based on the meta-data, a matching audio stream that was generated by Sound Generator 110 during the event may be retrieved and used to generate the multimedia stream in accordance with the disclosed subject matter.

It will be noted that though the present disclosure discusses audio and video streams, the disclosed subject matter may be applicable to streams of other types and other combinations of streams. As an example only, two audio streams—one generated by Sound Generator 110 and one generated by Mobile Device 135—may be synchronized and binded together, such as overlaid one on top of the other. Additionally or alternatively, a video stream generated by a device similar to Sound Generator 110, such as, for example, a digital video art player, may be binded with another stream recorded by a mobile device, such as 135.

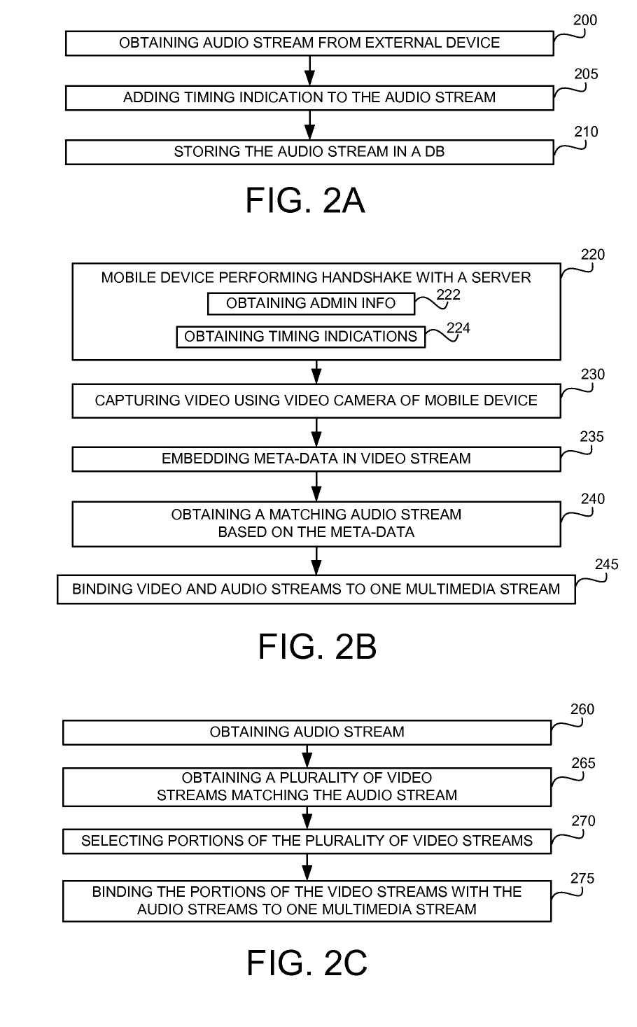

Referring now to FIG. 2A showing a flowchart diagram of steps in a method in accordance with some exemplary embodiments of the disclosed subject matter.

In Step 200 an audio stream may be obtained. The audio stream may be an audio stream generated by a Sound Generator, such as 110 of FIG. 1A, or by any other device which is external to a mobile device used by a member of the audience. In some exemplary embodiments, the audio stream may be obtained in its digital form before being transformed to an analog form and emitted via a system of speakers deployed in an event.

In Step 205, timing indications may be added to the audio stream. Timing indications may be embedded as meta-data indicating time in which the stream begins, thereby implying timing of each sound bit within the audio stream as an offset from the initial time of the stream. Additionally or alternatively, timing indications may be embedded within the stream based on periodic pulses.

In some exemplary embodiments, additional meta-data information may be introduced to the audio stream, such as but not limited to, administrative information describing the event, such as for example a unique identifier of the event; licensing information such as ownership of a copyright of the audio stream, identification of the performers, or the like; geo-location of the event, number of active and/or inactive users in the crowd, or the like.

In Step 210, the audio stream may be stored in a DataBase (DB) of audio streams. The DB may be used in a later time to retrieve the audio stream in order to bind it with a video stream and produce a multimedia stream.

In some exemplary embodiments, the audio stream may be used on-the-fly to produce a multimedia stream by streaming the audio stream to a device which performs said binding operation. Additionally or alternatively, the audio stream may be binded off-the-fly in a later timing. In some exemplary embodiments, a first user, such as 130, may generate the multimedia stream on-the-fly while a second user, such as 140, may generate the multimedia stream later on.

Referring now to FIG. 2B showing a flowchart diagram of steps in a method in accordance with some exemplary embodiments of the disclosed subject matter.

In Step 220, a mobile device, such as 135, may perform a handshake operation with a local server, such as 110. During the handshake operation the mobile device may obtain information useful for regulating access to the audio stream, for identifying matching audio stream and for synchronizing between the streams. As an example only, administrative information, such as event identification, event location, may be obtained (222). Additionally or alternatively, timing indication may be obtained (224) to facilitate synchronization of the clocks of the mobile device used by the audience with that of the server generating the audio stream.

In Step 230, a video stream may be captured by a camera of a mobile device, such as 135.

In Step 235, meta-data information may be embedded in the video stream. The meta-data may include information obtained during the handshake. In some exemplary embodiments, the meta-data may include a geo-location of the mobile device that can be determined by the mobile device, such as based on Wi-Fi triangulation, based on GPS, or based on other positioning system used by the mobile device.

In Step 240, a matching audio stream may be obtained. In some exemplary embodiments, the matching audio stream may be obtained directly from the local server, such as by streaming the audio stream via a wireless network, such as Wi-Fi, to the mobile device. Additionally or alternatively, the matching audio stream may be obtained from a remote server, either on-the-fly or in a later timing. In some exemplary embodiments, the remote server may retrieve the matching audio stream from the DB, such as based on the meta-data of the video stream. In one embodiment, based on the current geo-location of the mobile device, an audio stream being generated in the same location or which was recently generated within a predetermined timeframe in the same location or in its vicinity may be retrieved. Additionally or alternatively, the matching audio stream may be identified based on the initial time of the event, based on the event identifier, or based on other meta-data information useful for identifying the event and streams generated based thereon.

In some exemplary embodiments, obtaining the matching audio stream may require purchasing a license to the audio stream. In some exemplary embodiments, the price of the audio stream may depend on the quality thereof and a user may select between a multiple audio streams of different qualities that were generated in the same event. Additionally or alternatively, the cost of the license may differ for users that attended in the event, such as it may be a reduced price to a user who attend the event in comparison to a user who did not attend the event. The system may determine that the user attended the event based on information obtained during handshaking operation (220). In some exemplary embodiments, the information may include an encrypted identified of the mobile device to ensure that the information is not simply copied to another device to get a reduced price.

In some exemplary embodiments, the user may select a specific feature, such as a song, a portion of the event, or the like, for which an audio stream is desired. The matching audio stream may be limited to the selection of the user.

In Step 245, the video and audio streams may be binded to produce a multimedia stream. In some exemplary embodiments, the video stream may be accompanied by an original audio stream, which may or may not be a distorted version of the audio stream. In Step 245, the original audio stream may be dropped or may be integrated into the audio stream to include heard voices of the crowd, such as comments by the audience, cheering, or the like.

Referring now to FIG. 2C showing a flowchart diagram of steps in a method in accordance with some exemplary embodiments of the disclosed subject matter.

In Step 260, an audio stream may be obtained. In some exemplary embodiments, the audio stream may be obtained from a DB, may be selected from the DB based on meta-data, or the like. In some exemplary embodiments, the audio stream may be selected by a user.

In Step 265, a plurality of video streams that match the audio stream may be obtained. The video streams may be video streams which were generated by different members of the audience during an event in which the audio stream was played. In some exemplary embodiments, the video streams may be obtained from a DB of video streams, such as for example, an online website of video clips such as YouTube®.

In Step 270, portions of the video streams may be selected. The portions may correlate to different timings thereby editing from a plurality of video streams a mosaic video stream. The selection may be performed by a user, such as an editor (not shown).

In Step 275, the mosaic video stream may be binded with the audio stream to produce a multimedia stream.

In some exemplary embodiments, the editor may crowdsource the crowd to obtain video streams best suitable in his eyes to appear in a clip of the event. In some exemplary embodiments, different editors may produce different clips based on different video streams and/or selected portions thereof. In some exemplary embodiments, the members of the crowd may upload the video streams and decide whether or not to allow for the use of the video streams as part of a mosaic video stream.

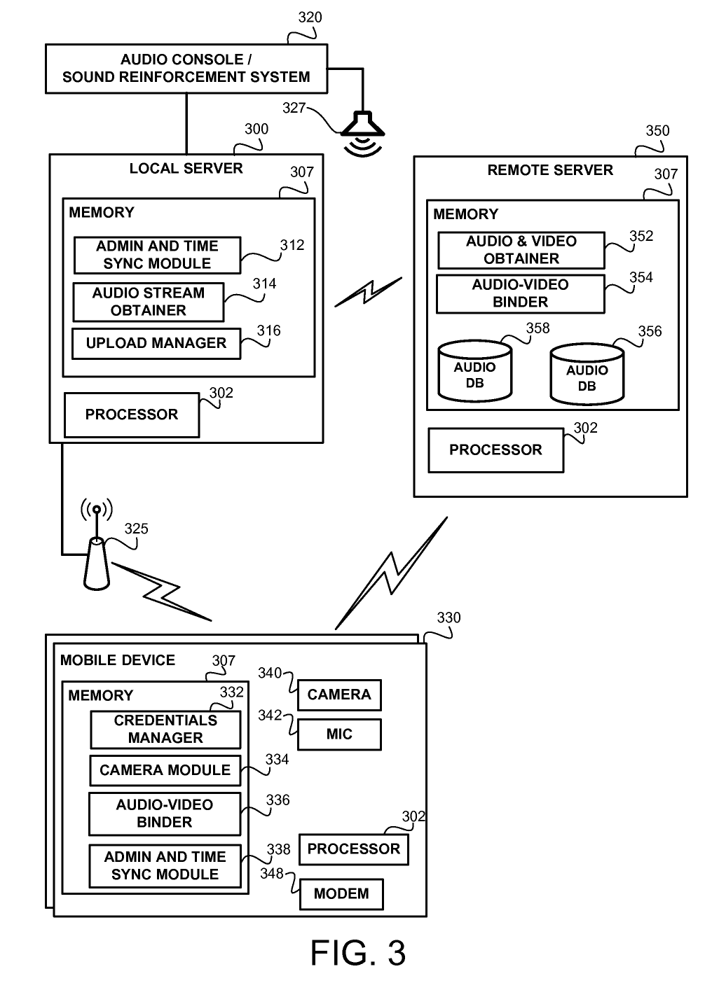

Referring now to FIG. 3 shows a block diagram of components of a system, in accordance with some embodiments of the disclosed subject matter.

A Local Server 300, such as Sound Generator 110, may comprise a Processor 302. Processor 302 may be a Central Processing Unit (CPU), a microprocessor, an electronic circuit, an Integrated Circuit (IC) or the like. Alternatively, Local Server 300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). Processor 302 may be utilized to perform computations required by Local Server 300 or any of it subcomponents.

In some exemplary embodiments, Local Server 300 may be a mobile phone, a smart phone, a tablet computer, a PDA, a desktop computer, a server, or the like.

In some exemplary embodiments, Local Server 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIG. 2A-2C.

It will be appreciated that Server 350 and Mobile Device 330 may also comprise Memory Unit 307 and Processor 302, however each apparatus may be equipped with a different memory unit and/or processor and the configuration of each such components may differ from one apparatus to another.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

Admin and Time Sync Module (ATSM) 312 may be configured to synchronize clock (not shown) of Local Server 300 with a clock (not shown) of Mobile Device 300 (not shown). ATSM 312 may be configured to transmit time information to Mobile Device 300, such as via a wireless connection using Local Access Point 325. In some exemplary embodiments, ATSM 312 may be configured to transmit to Mobile Device 330 with administrative information such as for example unique identification of the event. In some exemplary embodiments, Mobile Device 330 obtaining information provided by ATSM 312 may be used as an indication that Mobile Device 330 was present at the event. In some exemplary embodiments, the information may be encoded to indicate a unique identification of Mobile Device 330 so as to ensure that the information is no transmitted by Mobile Device 330 to another mobile device which was not present at the event. In some exemplary embodiments, the encoding may be based on a mobile phone number of the Mobile Device 330 thereby enabling the owner of the Mobile Device 330 to replace Mobile Device 330 without losing his or her credentials.

Audio Stream Obtainer 314 may be configured to obtain an audio stream, such as from a device external to Mobile Device 330. The audio stream may be obtained, for example, from an Audio Console/Sound Reinforcement System 320 that is utilized in the event for providing the sound to Speaker 327. In some exemplary embodiments, the audio stream may be obtained in digital form. In some exemplary embodiments, Audio Stream Obtainer 314 may be configured to embed in the audio stream timing indications, geo location, event identification, licensing information, or other meta-data information useful for the implementation of the disclosed subject matter.

In some exemplary embodiments, Memory Unit 307 of Local Server 300 may retain the audio stream obtained by Audio Stream Obtainer 314.

Upload Manager 316 may be configured to transmit the audio stream to the Mobile Device 330 and/or to Server 350. In some exemplary embodiments, Upload Manager 316 may be configured to transmit, via a wireless network, such as a Wi-Fi network, the audio stream to Mobile Device 330. In some exemplary embodiments, the audio stream may be streamed to Mobile Device 330. Additionally or alternatively, the audio stream may be transmitted in a non-streaming manner. In some exemplary embodiments, Upload Manager 316 may be configured to upload the audio stream to Server 350 via a computerized network, such as but not limited to the Internet, an intranet, a Local Area Network (LAN), a Wide Area Network (WAN), a Wireless LAN (WLAN), or the like.

In some exemplary embodiments, Mobile Device 330 may be located in the event, in the proximity of the event, or the like. In some exemplary embodiments, the disclosed subject matter may be applicable to a plurality of mobile devices, however for the clarity of the disclosure, a single Mobile Device 330 is referred to.

Mobile Device 330 may comprise Memory Unit 307, Processor 302. In some exemplary embodiments, Mobile Device 330 may comprise a Modem 348, a receiver, or a similar component enabling mobile device to communicate with other computerized devices. In some exemplary embodiments, Modem 348 may enable Mobile Device 330 to connect to Local Access Point 325. Additionally or alternatively, Modem 348 may enable Mobile Device 330 to communicate with Local Server 300 in a different manner. Additionally or alternatively, Modem 348 may enable Mobile Device 330 to communicate with Server 350 such as via the Internet, an intranet, a LAN, a WAN, a WLAN, or the like. In some exemplary embodiments, Modem 348 may utilize a mobile data connection, such as for example a 3G data connection, a 4G data connection, or the like.

In some exemplary embodiments, Mobile Device 330 may comprise a Camera 340 capable of capturing a video stream. Additionally or alternatively, a Microphone 342 may be capable of capturing an audio stream. Camera 342 and Microphone 342 may be controlled by the user via a module such as Camera Module 334.

Admin and Time Sync Module (ATSM) 338 may be configured to receive administrative information from Local Server 300 and embed them into video stream captured by Camera 340. In some exemplary embodiments, ATSM 338 may be configured to receive timing indications from Local Server 300 to enable synchronization of the video stream with the audio stream obtained by Audio Stream Obtainer 314 of Local Server 300. In some exemplary embodiments, based on timing indications received from Local Server 300, a clock of Mobile Device 330 may be set. Additionally or alternatively, an offset between the clock of the Mobile Device 330 and the timing indications may be computed and stored to be used for synchronization.

In some exemplary embodiments, timing indications may be periodically transmitted by Local Server 300 and received by Mobile Device 330 and used to ensure that the clocks did not go out of synchronization.

In some exemplary embodiments, Mobile Device 330 may be configured to obtain the audio stream, either directly from Local Server 300 or from Server 350. In some exemplary embodiments, the audio stream may be stream. Additionally or alternatively, the audio stream may be downloaded. In some exemplary embodiments, obtaining the audio stream by Mobile Device 330 may be performed by Credentials Manager 332 which may ensure that the Mobile Device 330 has sufficient access privileges to obtain the audio stream. In some exemplary embodiments, privilege may be given based on paying a licensing fee, based on attending the event, or the like. In some exemplary embodiments, several versions of the audio streams may be available, such as each having a different quality. The user of Mobile Device 330 may select which of the versions he or she would like to obtain and accordingly pay a licensing fee of the selected version. In some exemplary embodiments, the user may select which feature, song, or portion of the event he or she would like to obtain, and credentials Manager 332 may be configured to accordingly obtain a portion of the audio stream correlating to the selection of the user.

Audio-Video Binder (AVB) 336 may be configured to bind an audio stream captured by an external device to Mobile Device 330 (e.g., 320) and a video stream captured by Camera 340 or by a different device than the external device. AVB 336 may be configured to synchronize between the two streams based on timing indications. AVB 336 may be configured to correlate between frames of the video stream and sound bites of the audio stream based on their respective timing.

In some exemplary embodiments, AVB 336 may be configured to obtain a audio stream that matches the video stream. In case the audio stream is streamed or downloaded in real-time, matching may be implicit. Additionally or alternatively, when the binding is performed after the video stream was captured, the matching audio steam may be obtained from an audio database 356 in Server 350.

Referring now to Server 350, which may comprise Memory Unit 307 and Processor 302. Audio & Video Obtainer (AVO) 352 may be configured to obtain audio streams from Local Server 300. In some exemplary embodiments, AVO 352 may obtain audio streams from a plurality of local servers, such as for example, each being deployed at a different event location. Additionally or alternatively, AVO 352 may be configured to obtain video streams from mobile devices such as Mobile Device 330. The audio and video streams may be retained in an audio database 356 and video database 358 respectively.

In some exemplary embodiments, AVB 354 may be similar to AVB 336. AVB 354 may be capable of generating a mosaic stream, such as mosaic video stream based on a plurality of video streams, each potentially captured by a different mobile device, and potentially providing a different documentation of the same event. AVB 354 may be configured to bind between the mosaic video stream and the audio stream. In some exemplary embodiments, the mosaic video stream may be stored in an electronic storage to be used in at a later time.

In some exemplary embodiments, a mosaic stream may be generated based on user selection of portions of streams that document the same event. The streams may be obtained from a database, such as 356 or 358.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computerized system comprising:
a mobile device comprising a video camera configured to capture a video stream; and
an audio-video binding module, implemented using at least a processor, wherein said synchronization module is configured to generate a multimedia stream comprising the video stream and an audio stream, wherein the audio stream is generated by an external device to the mobile device and wherein said audio-video binding module is configured to synchronize between the audio and video streams based on correlating timing indications in both the audio and video streams.

2. The computerized system of claim 1, wherein said mobile device comprising said audio-video binding module.

3. The computerized system of claim 1, wherein said mobile device comprising a receiver configured to receive from an external source the timing indications during capturing of the video stream, and wherein correlating timing indications are comprised in the audio stream.

4. The computerized system of claim 1, wherein audio-video binding module is comprised by a server, wherein the server is configured to obtain a plurality of video streams from a plurality of mobile devices and generate the multimedia stream based on the plurality of video streams and the audio stream.

5. The computerized system of claim 4, wherein the server is configured to provide for a crowd-sourced music clip of a live show performed in a location, and wherein the plurality of mobile devices were located at the location and were used to record the live show at least using their respective video cameras.

6. The computerized system of claim 4, wherein the server is configured to select portions of the plurality of video streams based on user input.

7. The computerized system of claim 1 further comprising a video-audio matcher, wherein said video-audio matcher is configured to obtain the audio stream that correlates to the video stream based on meta-data of the video stream.

8. The computerized system of claim 7, wherein the meta-data comprises: geo-location in which the video stream was recorded and time of recording.

9. The computerized system of claim 7, wherein the meta-data comprises a unique identifier of a show, wherein the meta-data was obtained by a receiver of the mobile device substantially during a time in which the mobile device recorded the video stream.

10. The computerized system of claim 1, wherein said audio-video binding module is operatively coupled to a rights management module, wherein the rights management module is configured to provide access to copyrighted audio streams in response to payment.

11. The computerized system of claim 1, wherein the audio stream is generated by a sound reinforcement system, wherein the mobile device captured the video stream while located at a location in which audio emitted by the sound reinforcement system is audible.

12. The computerized system of claim 1, wherein the mobile device is capable of capturing a distorted version of the audio stream.

13. The computerized system of claim 12, wherein the distorted version of the audio stream is distorted due to at least one of the following:
a limitation of a microphone of the mobile device; and
background noise by a crowd.

14. A computer-implemented method performed by a processor, the method comprising:
obtaining an audio stream and a video stream, wherein the video stream was captured by a mobile device having a camera, and wherein the audio stream was captured by an external device that is external to the mobile device; and
binding, by the processor, the audio stream and the video stream to generate a multimedia stream comprising the audio stream and video stream, wherein said binding comprising synchronizing between the audio stream and the video stream based on correlating timing indications in both the audio and video streams.

15. The method of claim 14, wherein the mobile device comprising the processor, and said binding is performed by the mobile device.

16. The method of claim 14, wherein the audio and video streams each comprising timing indications, wherein the timing indications are generated by an external source to the mobile device and transmitted to both the mobile device and the external device simultaneously.

17. The method of claim 14, wherein the mobile device receiving the audio stream while capturing the video stream, and wherein said binding is performed in real-time.

18. The method of claim 14, wherein said binding is performed in response to authorizing access to the audio stream.

19. The method of claim 18, wherein said authorizing is based on a payment of a licensing fee.

20. The method of claim 18, wherein said authorizing comprises determining whether the video stream was captured at a same location in which a distorted version of the audio stream was recordable by the mobile device, whereby enabling a user of the mobile device to capture the video stream and an undistorted version of the audio stream.
